(19) United States
(12) Patent Application Publication
(10) Pub. No.: US 2014/0289739 A1
(43) Pub. Date: Sep. 25, 2014

(54) ALLOCATING AND SHARING A DATA OBJECT AMONG PROGRAM INSTANCES

(71) Applicant: HEWLETT-PACKARD DEVELOPMENT COMPANY, L.P., (US)

(72) Inventors: Erik Tamas Bodzsar, Chicago, IL (US); Indrajit Roy, Mountain View, CA (US)

(73) Assignee: HEWLETT-PACKARD DEVELOPMENT COMPANY, L.P., Houston, TX (US)

(21) Appl. No.: 13/847,717

(22) Filed: Mar. 20, 2013

(51) Int. Cl. G06F 9/54

(52) U.S. Cl. CPC G06F 9/544
USPC 719/312

(57) ABSTRACT

A memory has a shared data object containing shared data for a plurality of program instances. An allocation routine allocates a respective memory region corresponding to the shared data object to each of the plurality of program instances, where each of the memory regions contains a header part and a data part, where the data part corresponds to the shared data and the header part contains information relating to the data part, and the header part is private to the corresponding program instance. The allocation routine maps the shared data to the memory regions using a mapping technique that avoids copying the shared data to each of the data parts as part of allocating the corresponding memory region.

### BACKGROUND

Certain computer programming languages are specialized programming languages that have been developed for specific types of data or specific types of operations. For example, array-based programming languages can be used to produce programs that can perform operations that involve matrix computations (computations involving multiplication of matrices or vectors, for example) in a more efficient manner. Matrix computations can be used in machine-learning applications, graph-based operations, and statistical analyses.

However, some array-based programming languages may be single-threaded programming languages that do not scale well when processing large data sets. A program according to a single-threaded language is designed to execute as a single thread by a processor or a computer. Processing a relatively large data set using a single-threaded program can result in computations that take a relatively long time to complete.

### BRIEF DESCRIPTION OF THE DRAWINGS

Some embodiments are described with respect to the following figures:

FIG. 1 is a block diagram of a system that includes a master process and worker processes, according to some implementations;

FIGS. 2A and 2B depict sharing of a data object that is accessible by multiple program instances according to some examples;

FIG. 3 is a schematic diagram illustrating a worker process that is associated with multiple program instances, where a shared data object can be allocated to the program instances according to some implementations;

FIG. 4 is a schematic diagram of an arrangement for allocating a shared data object to a program instance, according to some implementations;

FIG. 5 is a flow diagram of a shared data object allocation process according to some implementations; and

FIG. 6 is a flow diagram of a memory allocation process according to further implementations.

### DETAILED DESCRIPTION

Examples of array-based programming languages include the R programming language and the MATLAB programming language, which are designed to perform matrix computations. The R programming language is an example of an array-based programming language that is a single-threaded language. A program produced using a single-threaded language is a single-threaded program that is designed to execute as a single thread on a processing element, which can be a processor or computer. Although reference is made to the R programming language as an example, it is noted that there are other types of single-threaded languages.

As noted above, an issue associated with a single-threaded program is that its performance may suffer when applied to a relatively large data set. Because the single-threaded program is usually designed to execute on a single processor or computer, the program can take a relatively long time to complete if the program performs computations on relatively large data sets.

In accordance with some implementations, techniques or mechanisms are provided to allow for programs written using a single-threaded programming language and its extensions to execute in an efficient manner as multiple program instances in a distributed computer system. A distributed computer system refers to a computer system that has multiple processors, multiple computers, and so forth. A processor can refer to a processor chip or a processing core of a multi-core processor chip.

In the ensuing discussion, reference is made to R program instances, where an R program instance can refer to an instance of an R program (written according to the R programming language). Note that an R program instance is a process that can execute in a computing system. However, even though reference is made to R program instances, it is noted that techniques or mechanisms according to some implementations can be applied to program instances of other single-threaded programming languages.

An example technique of parallelizing an R program is to start multiple worker processes on respective processors within a computer. A worker process is a process that is scheduled to perform respective tasks. In the foregoing example, one instance of the R program can be associated with each respective worker process. However, distributing R program instances in this manner may not be efficient, since multiple copies of shared data has to be made for each R program instance that is associated with a respective worker process.

Shared data refers to data that is to be accessed by multiple entities, such as the multiple R program instances. Making multiple copies of shared data can increase the amount of storage space that has to be provided as the number of R program instances increase. Also, in such an example, shared data may have to be communicated between worker processes, which can take up network bandwidth and can take some time. In addition, as the number of worker processes increase, the amount of network communication increases. The foregoing issues can inhibit the scalability of single-threaded program instances when applied to relatively large data sets.

In accordance with some implementations, rather than start multiple worker processes for respective R program instances, one worker process can be associated with multiple R program instances. Such a worker process is considered to encapsulate the multiple R program instances, since the worker process starts or invokes the multiple R program instances, and the R programming instances work within the context of the worker process. The R program instances associated with a worker process can have access to shared data in a memory, which can be achieved with zero copying overhead.

Zero copying overhead refers to the fact that no copies of the shared data have to be made as a result of invoking multiple R program instances that are able to share access of the shared data. Zero copying overhead is achieved by not having to copy the shared data each time the shared data is allocated to a respective R program instance. Rather, a memory allocation technique can be used in which a memory region for shared data can be allocated to each of the multiple R programming instances associated with a worker process, but the shared data is not actually copied to each allocated memory region. Instead, a redirection mechanism is provided with the allocated memory region. The redirection mechanism redirects an R program instance to the actual location of the shared data whenever the R program instance performs an access (e.g. read access or write access) of the shared data.

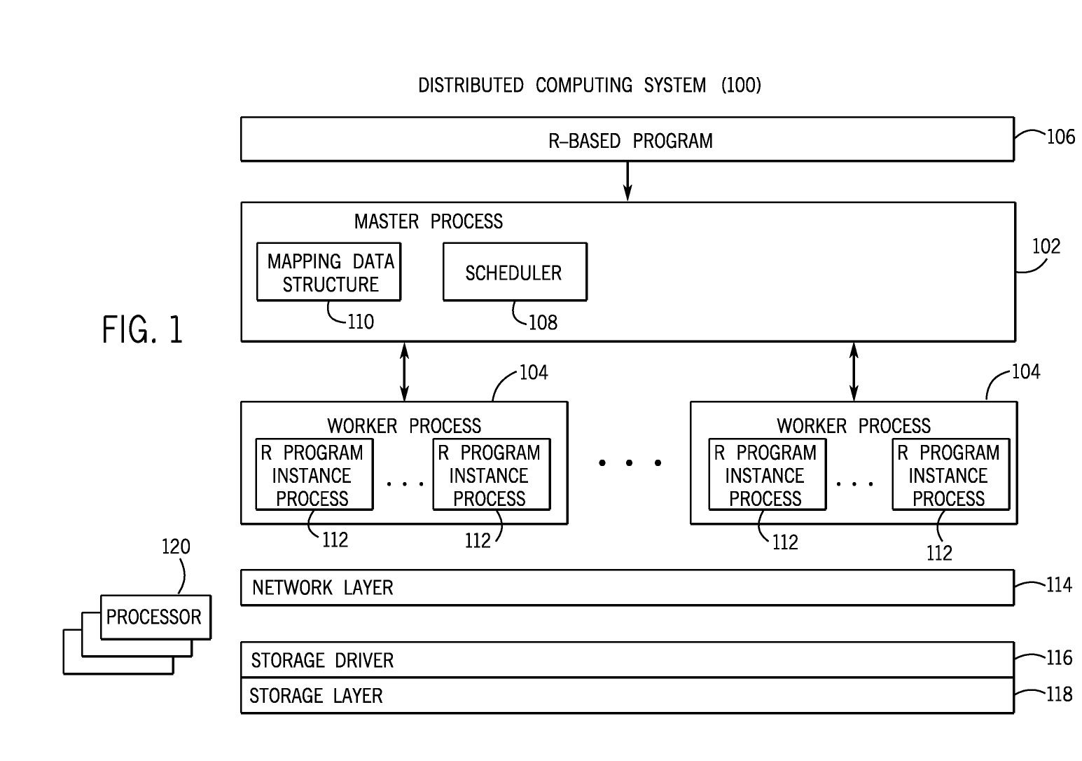

FIG. 1 is a block diagram of an example distributed computer system 100 that includes a master process 102 and multiple worker processes 104. Note that each worker process 104 can be executed on an individual computer node, or alternatively, more than one worker process can be executed on a computer node. The distributed computer system 100 can include multiple computer nodes, where each computer node includes one or multiple processors. Alternatively, the distributed computer system includes one computer node that has multiple processors. A computer node refers to a distinct machine that has one or multiple processors.

A program 106 (based on the R language) can be executed in the distributed computer system 100. The program 106 is provided to the master process 102, which includes a task scheduler 108 that can schedule tasks for execution by respective worker processes 104. The master process 102 can execute on a separate computer node than the computer node(s) including the worker processes 104. Alternatively, the master process 102 can be included in the same computer node as a worker process 104.

Although reference is made to a master process and worker processes in this discussion, it is noted that techniques or mechanisms can be applied in other environments. More generally, a scheduler (or multiple schedulers) can be provided in the distributed computing system 100 that is able to specify tasks to be performed by respective processes in the distributed computing system 100. Each process can be associated with one or multiple singled-threaded program instances.

Multiple R program instances 112 (or equivalently, R program processes) can be started or invoked by each worker process 104. The R program instances 112 started or invoked by a given worker process 104 is encapsulated by the given worker process 104.

The master process 102 also includes a mapping data structure 110 (also referred to as a mapping table or symbol table) that can map variables to physical storage locations. A variable is used by an R program instance and can refer to a parameter or item that can contain information. The mapping data structure 110 can be used by worker processes 104 to exchange data with each other through a network layer 114. The network layer 114 can include network communication infrastructure (such as wired or wireless links and switches, routers, and/or other communication nodes).

Note that although worker processes 104 can communicate data among each other, the R program instances 112 associated with each worker process 104 do not have to perform network communication to exchange data with each other, which reduces data transfer overhead.

The distributed computer system 100 also includes a storage driver 116, which is useable by worker processes for accessing a storage layer 118. The storage layer 118 can include storage device(s) and logical structures, such as a file system, for storing data.

The distributed computing system 100 further includes processors 120, which can be part of one or multiple computer nodes.

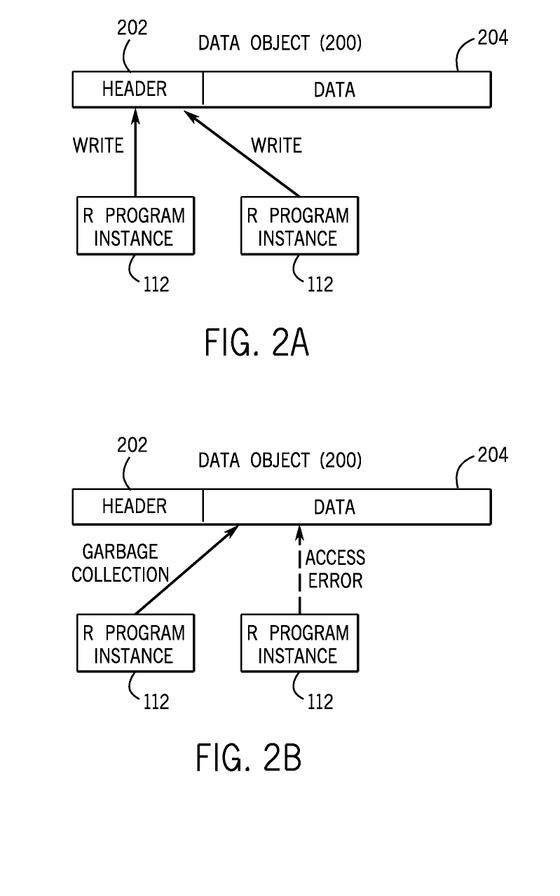

Data accessible by R program instances 112 can be included in data objects (also referred to as R data objects). A data object can have a header part and a data part. One example of such an arrangement is shown in FIG. 2A, which shows a data object 200 having a header part 202 and a data part 204. The data part 204 includes actual data, whereas the header part 202 includes information (metadata) relating to the data part 204. For example, the information included in the header part 202 can include information regarding the type and size of the corresponding data in the data part 304.

FIG. 2A also shows two R program instances 112 sharing the data object 200. In the example of FIG. 2A, it is assumed that sharing of the data object 200 is accomplished by pointing a variable of each of the two R program instances 112 corresponding to the data object 200 to an external data source, which in this case includes the data object 200. An external data source refers to a storage location that is outside of a local memory region for an R program instance 112. However, with this data sharing technique, write corruption can occur when both R programming instances 112 attempt to write the header part 202 that is part of the data object 200 located in the external data source. For example, in FIG. 2A, the two R program instances 112 may attempt to write inconsistent values to the header part 202, which can lead to corruption of the header part 202.

Note that the R programming language provides garbage collection. Garbage collection refers to a memory management technique in which data objects that are no longer used can be deleted to free up memory space. FIG. 2B illustrates an example in which a first one of the R program instances 112 performs garbage collection with respect to the data object 200 by invoking a garbage-collection routine, after the first R program instance 112 determines that it no longer is using the data object 200. However, the second R program instance 112 may still be using the data object 200. If the garbage collection invoked by the first R program instance 112 causes deletion of the data object 200, then data access error can result if the second R program instance 112 subsequently attempts to access the deleted data object 200.

The data object sharing mechanism according to some implementations can address the foregoing issues discussed in connection with FIGS. 2A-2B.

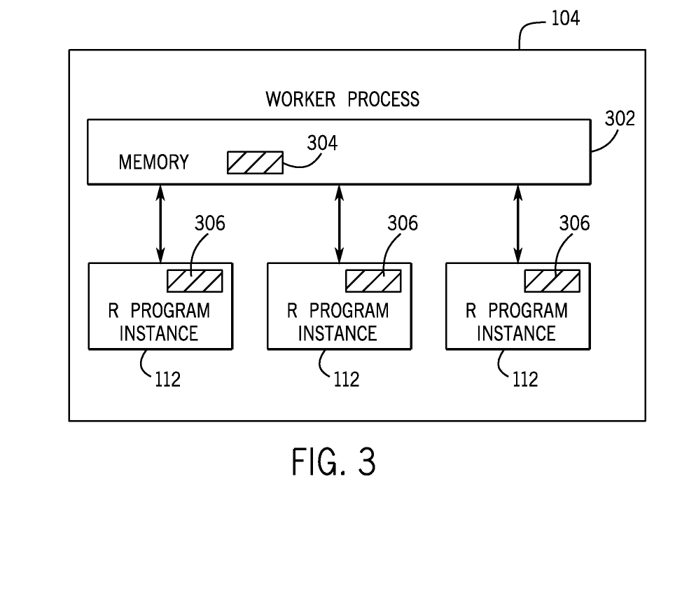

FIG. 3 illustrates a particular worker process 104 and associated R program instances 112. The worker process 104 is associated with a memory 302, which can be part of a memory subsystem that is included in the distributed computer system 100. The memory subsystem can include one or multiple memory devices, such as dynamic random access memory (DRAM) devices, flash memory devices, and so forth.

The memory 302 includes a shared data object 304 that can be shared among the R program instances 112 associated with the worker process 104. The shared data object 304 is allocated to each of the R program instances 112, such that each R program instance is allocated a respective memory region 306 that corresponds to the shared data object 304 in the memory 302. In accordance with some implementations, the allocation of the shared data object 304 involves mapping the shared data object 304 to the allocated memory regions 306, where data of the shared data object 304 is actually not copied to the allocated memory region 306 of each R program instance 112. Rather, the data of the shared data object 304 in the memory 302 is mapped to each memory region (virtual address space of the process) 306. Such mapping provides redirection such that when an R program instance 112 attempts to access data of the memory region 306, the requesting R program instance 112 is redirected to the storage location of the data in the shared data object 304 in the memory 302.

By allocating respective memory regions 306 allocated to the respective R program instances, the issue of write corruption due to inconsistent writes to the header part of the shared data object 304 (as discussed in connection with FIG. 2A) can be avoided. Also, when a particular one of the R program instances decides that the particular R program instance no longer has to access the shared data object 304, garbage collection is not performed if at least one other R program instance still accesses the shared data object 304. Instead, un-mapping can be performed to un-map the memory region 306 of the particular R program instance, without affecting the mapping of the memory region(s) 306 of the other R program instance(s) that continue to have access to the shared data object 304.

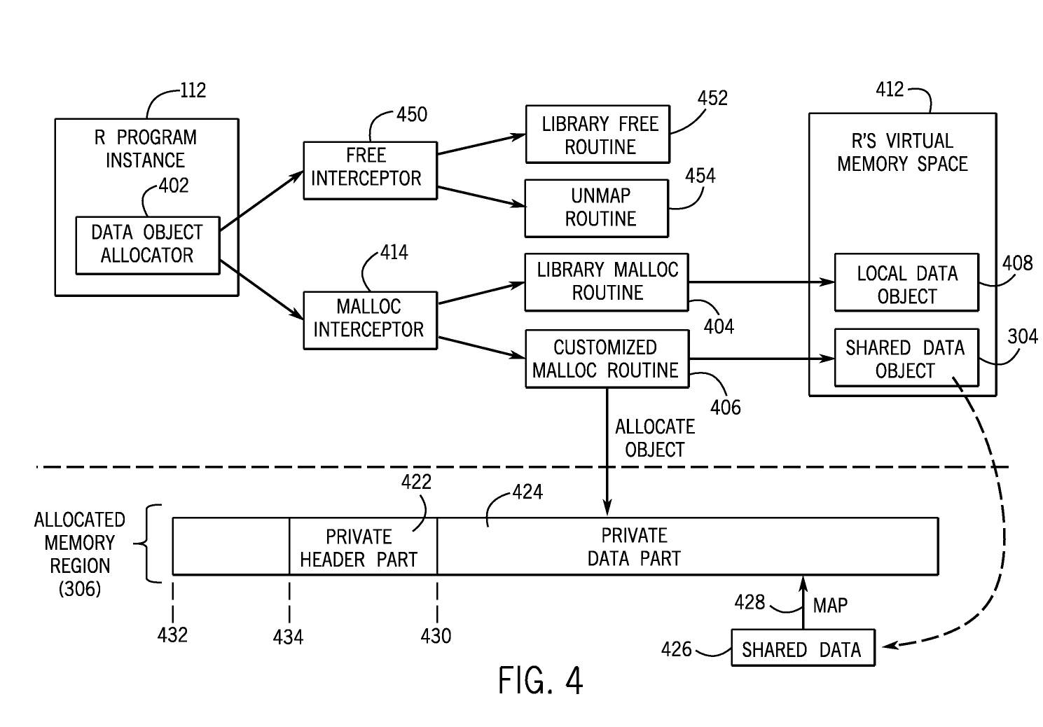

FIG. 4 is a schematic diagram of an arrangement for allocating a memory region for a shared data object to an R program instance 112, according to some implementations. The R program instance 112 includes a data object allocator 402, which is able to invoke a memory allocation routine, e.g. malloc( ) routine, to allocate a local memory region 306 for the R program instance 112 for a respective data object. The memory allocation routine is a system call routine that can be invoked by the data object allocator 402 in the R program instance 112.

As depicted in FIG. 4, there are two different memory allocation routines 404 and 406. A first memory allocation routine 404 is a library memory allocation routine that can be present in a library of the distributed computing system 100 of FIG. 1. In some examples, the library is a GNU library provided by the GNU Project, where “GNU” is a recursive acronym that stands for “GNU's Not Unix.” In such examples, the library memory allocation routine can also be referred to as a glibc malloc( ) routine. Although reference is made to the GNU library in some examples, it is noted that techniques or mechanisms according to some implementations can be applied to other environments.

The library memory allocation routine 404 can be used to allocate a memory region for placing data associated with a local (non-shared) data object 408, where the local data object 408 is a data object that is accessed only by the R program instance 112 and not by any other R program instance 112. The library memory allocation routine 404 would actually cause the data of the local data object 408 to be copied to the allocated local memory region.

On the other hand, the second memory allocation routine 406 is a customized memory allocation routine according to some implementations. The customized memory allocation routine 406 is invoked in response to a memory allocation for a shared data object 304 that is to be shared by multiple R program instances 112.

The local data object 408 and shared data object 304 are contained in a virtual memory space 412 for the R program instance 112. Note that the virtual memory space 412 refers to some virtual portion of the memory 202 associated with the R program instance 112 of FIG. 1. Each R program instance 112 is associated with a respective virtual memory space 412. A shared data object that is present in the virtual memory space 412 of the respective R programming instance 112 is actually located at one common storage location of the memory 202, even though the shared data object is considered to be part of the respective virtual memory spaces 412 of the R program instances 112 that share the shared data object 304.

A memory allocation interceptor 414 receives a call of a memory allocation routine (or more generally a memory allocation request), such as a call of the malloc( )routine, by the data object allocator 402. The interceptor 414 can determine whether the called memory allocation routine is for a local data object or a shared data object. If the interceptor 414 determines that the call is for the local data object 408, then the interceptor 414 invokes the library memory allocation routine 404. On the other hand, if the interceptor 414 determines that the target data object is the shared data object 304, then the interceptor 414 invokes the customized memory allocation routine 406.

In some examples, the memory allocation interceptor 414 can include hook function, such as the malloc_hook function of the GNU library. The malloc_hook function produces a pointer to a respective routine to invoke in response to a malloc( ) call. In the example of FIG. 4, the pointer can be to either the library memory allocation routine 404 or the customized memory allocation routine 406, depending on whether the data object to be allocated is a local data object or shared data object.

FIG. 4 further depicts how the customized memory allocation routine 406 allocates the shared data object 304 to the R program instance 112, in response to a memory allocation call from the data object allocator 402. The allocation performed by the customized memory allocation routine 406 results in allocation of a local memory region 306, which is a memory region dedicated (or private) to the R program instance 112. The local memory region 306 has a private header part 422 and a private data part 424. Both the private header part 422 and private data part 424 are private to the corresponding R program instance 112; in other words, they are not visible to other R program instances 112.

The private header part 422 can contain some of the information copied from the header part of the shared data object 304. Note that the header information in the private header part 422 is local to each R program instance 112, and thus, a write to the header information in the private header part 422 by the R program instance 112 does not result in a write conflict with a write to the respective private header part 422 of another R program instance 112.

In accordance with some implementations, instead of copying shared data (426) of the shared data object 304 into the private data part 424, the shared data 426 is instead mapped (at 428) to the private data part 424. In some implementations, the mapping (at 428) can be performed using an mmap( ) routine or other shared memory techniques.

The mmap( )routine or other shared memory technique provide a master copy of data (e.g. the shared data 426 of the shared data object 304) that can be shared by multiple R program instances 112. Redirection is used to redirect an R program instance 112 accessing the private data part 424 to the actual storage location of the master copy of data. In this way, multiple copies of the shared data 426 would not have to be provided for respective R program instances 112.

As examples, the mmap( ) routine or other shared memory technique can establish an application programming interface (API) that includes a routine or function associated with the local memory region 306, where the API routine or function can be called by an R program instance 112 to access the shared data 426. Whenever an R program instance 112 makes a call of the API to access the shared data 426, the R program instance 112 is redirected to the actual storage location of the shared data 426 in the shared data object 304.

In some implementations, sharing is enabled for just read-only data (data that can be read but not written). In such implementations, read-write data (data that may be written) is not shared. In other implementations, read-write data can be shared, if locks or other data integrity mechanisms are implemented to coordinate writing by multiple R program instances of the read-write data.

When the shared data object 306 is no longer used by an R program instance, rather than use a standard garbage collection technique, a customized technique can be used instead. In some examples, the data object allocator 402 can call a free( ) routine to apply garbage collection when a data object is no longer used. The free( ) routine can be the free( ) routine that is part of the GNU library, for example. However, to avoid performing garbage collection on the shared data object 304 when the shared data object 304 is still being used by at least another R program instance, a free interceptor 450 is provided to determine whether to call a library free routine 452 or an unmap routine 454, in response to a call of the free( ) routine by the data object allocator 402. In some examples, the free interceptor 450 can include a hook function, such as the free_hook function of the GNU library.

The free interceptor 414 can maintain a list of shared data objects that were allocated using the customized memory allocation routine 406, where the list contains the starting address and the allocation size of each of the shared data objects that were allocated using the customized memory allocation routine 406. Whenever the free( ) function is called, the free interceptor 414 checks if the data object to be freed is present in the list. If so, the free interceptor 414 invokes the unmap routine 454, such as munmap( ) rather than the library free routine.

The unmap routine 454 un-maps the shared data 426 from the private data part 424 for the requesting R program instance 112, and also reclaims a storage space for the header part corresponding to requesting R program instance 112. The un-mapping and storage space reclamation does not change the mapping of other R program instances that have access to the shared data object 304. In this way, the other R program instances 112 can continue to have access to the shared data object 304.

More generally, techniques or mechanisms are provided that can respond to a garbage collection request (in the form of a call of the free( ) routine, for example), by checking a data structure to determine whether the data object that is the subject of the garbage collection request is in the data structure. If so, then garbage collection is not performed in response to the garbage collection request. Instead, the data object that is the subject of the garbage collection request is un-mapped from the memory region allocated to the requesting R program instance, which does not result in deletion of the data object. As a result, other R program instances can continue to access the data object.

In some examples, an mmap( ) routine for mapping the shared data 426 to the private data part 424 locates data only to an address at a page boundary. Note that the memory region 306 can be divided into multiple pages, where each page has a specified size. The data object allocator 402 of the R program instance does not guarantee that the data part of the allocated memory region 306 will start at a page boundary. If the data part of allocated memory region 306 does not start at a page boundary, then the mmap( ) routine may not be used to map the shared data 426 to the private data part 424.

To address the foregoing issue, the behavior of the data object allocator 402 is overridden by the customized memory allocation routine 406 to ensure that the private data part 424 of the allocated memory region 306 starts at a page boundary (indicated by 430).

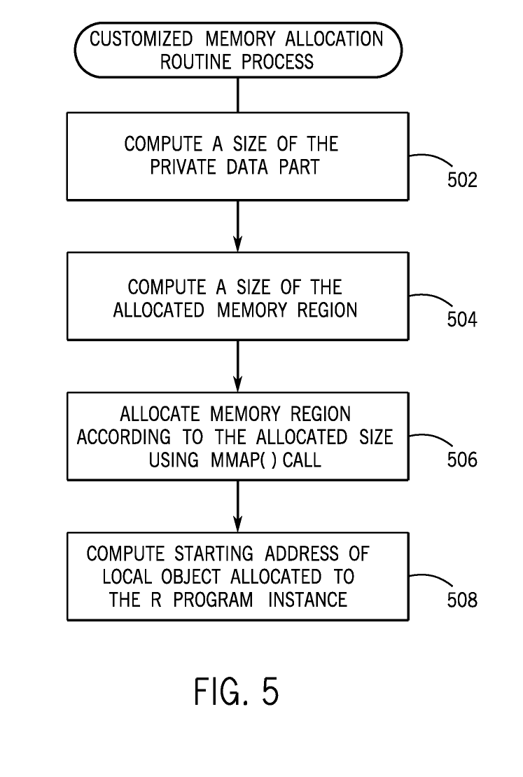

The process of the customized memory allocation routine 406 according to some implementations is discussed in connection with FIG. 5. The customized memory allocation routine 406 computes (at 502) the size of the private data part 424, which is based on the size of the shared data 426. The size (DATA) of the shared data 426 is computed as follows:

DATA=SIZE−HEADER,

where SIZE is the size of the shared data object 304, and HEADER is the size of the header part of the shared data object 304.

Next, the customized memory allocation routine 406 computes (at 504) the size (ALLOCSIZE) of the allocated memory region 306 as follows:

ALLOCSIZE=PGSIZE(HEADER)+DATA.

The function PGSIZE(HEADER) is a function that returns a value that is equal to the value of HEADER rounded up to the nearest multiple of the page size.

Next, the customized memory allocation routine 406 allocates (at 506) the memory region 306 of size ALLOCSIZE, starting at a page boundary (432 in FIG. 4). The allocation at 506 can use an mmap( ) call, with the MAP_ANONYMOUS flag set. The result of the mmap( ) all is ADDR, which identifies the page boundary 432 in FIG. 4. The MAP_ANONYMOUS flag when set is used to indicate that data should not be copied to persistent storage.

The value of ADDR represents the starting address of the allocated memory region 306. The customized memory allocation routine 406 then computes (at 508) the starting address of the local object that corresponds to the shared data object 304. The local object includes the private header part 422 and the private data part 424. This starting address is represented as 432 in FIG. 4. The starting address is computed as follows:

ADDR+PGSIZE(1)−HEADER,

where PGSIZE(1) is equal to one page size.

The foregoing returns a value that is equal to the starting address of the private header part 422. As can be seen in FIG. 4, the starting address of the private header part 422 can be offset from the starting address 430 (represented as ADDR) of the memory region 306. In fact, the starting address of the header part 422 may not be aligned to a page boundary.

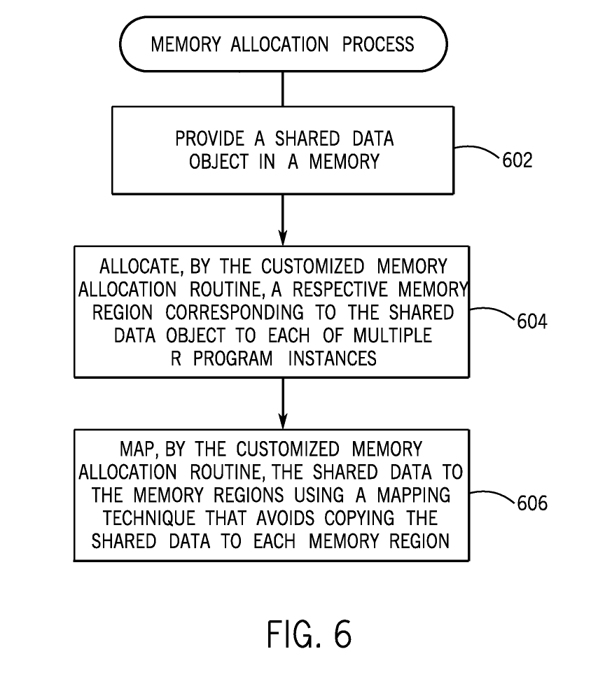

FIG. 6 is a flow diagram of memory allocation of a shared data object according to further implementations. The process of FIG. 6 provides (at 602) the shared data object 304 in the memory 302, where the shared data object contains shared data 426 accessible by multiple R program instances 112. The customized memory allocation routine 406 allocates (at 604) a respective memory region 306 corresponding to the shared data object to each of the plurality of program instances. Each of the memory regions 306 contains a header part and a data part, where the data part corresponds to the shared data and the header part contains information relating to the data part, and the header part is private to the corresponding program instance.

The customized memory allocation routine 406 next maps (at 606) the shared data 426 to the memory regions 306 using a mapping technique that avoids copying the shared data 426 to each of the data parts as part of allocating the corresponding memory region 306.

Machine-readable instructions of various modules described above can be loaded for execution on a processor or multiple processors (such as 120 in FIG. 1). A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
providing, in a computer system, a shared data object in a memory, the shared data object containing shared data for a plurality of program instances;
allocating, by an allocation routine in the computer system, a respective memory region corresponding to the shared data object to each of the plurality of program instances, wherein each of the memory regions contains a header part and a data part, where the data part corresponds to the shared data and the header part contains information relating to the data part, the header part being private to the corresponding program instance; and
mapping, by the allocation routine, the shared data to the memory regions using a mapping technique that avoids copying the shared data to each of the data parts as part of allocating the corresponding memory region.

2. The method of claim 1, wherein the plurality of program instances are instances of a program according to a single-threaded computer programming language.

3. The method of claim 1, further comprising:
in response to an access of the shared data by a given one of the plurality of program instances, redirecting the given program instance from the data part of the memory region allocated to the given program instance to the shared data in the shared data object.

4. The method of claim 1, wherein some of the information of the header part of each of the memory regions is copied from a header part of the shared data object, the method further comprising:
writing, by the plurality of program instances, to the corresponding header parts of the respective memory regions, wherein the writing to the header parts does not result in a write conflict.

5. The method of claim 1, further comprising:
intercepting a memory allocation call by a given one of the plurality of program instances;
determining whether or not the memory allocation call is for the shared data object; and
in response to determining that the memory allocation call is for the shared data object, invoking the allocation routine.

6. The method of claim 5, further comprising:
in response to determining that the memory allocation call is for a non-shared data object, invoking a second, different allocation routine to allocate the non-shared data object to the given program instance.

7. The method of claim 1, further comprising:
associating the plurality of program instances with a worker process of a number of worker processes.

8. The method of claim 1, further comprising:
maintaining a data structure identifying shared data objects;
in response to a request from a given one of the plurality of program instances to perform garbage collection on a target data object, determining whether the target data object is in the data structure; and
in response to determining that the target data object is in the data structure, performing un-mapping of the target data object from an allocated memory region for the given program instance and reclaiming a storage space for the header part corresponding to the given program instance, wherein the un-mapping and storage space reclamation does not affect access by the program instances of the target data object.

9. The method of claim 8, further comprising:
in response to determining that the target object is not in the data structure, performing garbage collection on the target data object.

10. A computing system comprising:
a memory to store a shared data object that contains shared data;
a plurality of processors;
program instances executable on the plurality of processors; and
a memory allocation routine executable in the computing system to:
responsive to a memory allocation request from a first of the program instances for allocating the shared data object, allocate a memory region corresponding to the shared data object to the first program instance, wherein the allocated memory region includes a header part and a data part, the data part mapped to the shared data, and the header part being private to the first program instance and containing information pertaining to the data part, and
wherein the data part is mapped to the shared data without copying the shared data to the data part.

11. The computing system of claim 10, further comprising:
an interceptor to receive the memory allocation request, the interceptor to selectively invoke the memory allocation routine or a second, different memory allocation routine responsive to a determination of whether or not a memory allocation request is for the shared data object or for a non-shared data object.

12. The computing system of claim 10, wherein the memory allocation routine is executable to further:
allocate the memory region that has a starting address at a page boundary.

13. The computing system of claim 12, wherein a starting address of the header part is offset from the starting address of the memory region, and is not aligned to a page boundary.

14. The computing system of claim 13, wherein a starting address of the data part is aligned to a page boundary.

15. The computing system of claim 10, further comprising:
an interceptor executable in the computing system to:
intercept a request from the first program instance to perform garbage collection on first data;
determine whether the first data is shared by another program instance; and
in response to determining that the first data is shared by another program instance, un-map the first data from an allocated memory region of the first program instance.

16. The computing system of claim 15, wherein the interceptor is executable to further:
in response to determining that the first data is not shared by another program instance, perform garbage collection on the first data.

17. The computing system of claim 10, wherein program instances are instances of a program according to a single-threaded computer programming language.

18. An article comprising at least one machine-readable storage medium storing instructions that upon execution cause a computer system to:
store a shared data object in a memory, the shared data object containing shared data for a plurality of program instances;
allocate, by an allocation routine, a respective memory region corresponding to the shared data object to each of the plurality of program instances, wherein each of the memory regions contains a header part and a data part, where the data part corresponds to the shared data and the header part contains information relating to the data part, the header part being private to the corresponding program instance; and
map, by the allocation routine, the shared data to the memory regions using a mapping technique that avoids copying the shared data to each of the data parts as part of allocating the corresponding memory region.

19. The article of claim 18, wherein the instructions upon execution cause the computer system to allocate each of the memory regions with a starting address aligned to a page boundary.

20. The article of claim 19, wherein the data part of each of the memory regions starts at a page boundary.
